(19) United States
(12) Patent Application Publication
(10) Pub. No.: US 2009/0233535 A1
(43) Pub. Date: Sep. 17, 2009

(54) ANIMAL CARCASS CARRIER

(76) Inventor: Jeffrey R. Boduch, Fenton, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/401,805

(22) Filed: Mar. 11, 2009

Related U.S. Application Data
(60) Provisional application No. 61/035,514, filed on Mar. 11, 2008.

(51) Int. Cl. A22B 5/00

(52) U.S. Cl. 452/187; 43/1

(57) ABSTRACT

A portable animal carrier designed for retrieving carcasses of large animals such as deer or other animals of similar size is provided by the present invention. In a specific embodiment, an animal carrier of the present invention includes two endpieces and an intermediate joining piece, pole handles, hand grips, rings, fasteners, cam locks, foam, leg straps, torso straps, a head strap and spring snap buttons. The two endpieces and intermediate joining piece assemble together to form a support pole from which an animal carcass is suspended. Two people lift the game animal carcass completely off the ground using a carrier of the present invention and easily move the animal to the desired location.

### REFERENCE TO RELATED APPLICATION

This application claims priority from U.S. Provisional Patent Application Ser. No. 61/035,514, filed Mar. 11, 2008, the entire content of which is incorporated herein by reference.

### FIELD OF THE INVENTION

The present invention relates generally to a portable game carrier. More specifically, the present invention relates to an assemblable support and attachable animal harness designed to be ergonomic, simple to use, easily assembled and easily transported by two people.

### BACKGROUND OF THE INVENTION

For years, hunters have tried with little success to design a device to combat the obstacles that are faced when trying to retrieve large game animals from the field. In previous designs, the animal is normally dragged across the ground or pulled or pushed on a wheeled cart making that design much more vulnerable to obstacles on the ground. Also, many previous designs such as wheeled carts and game dragging devices are designed to be used by one person. These designs require that the entire load of the animal be forced by the energy of one person making retrieval of the animal much more difficult. Poles of unitary construction have been used to carry animals, people and equipment but these poles are difficult to transport to a site of intended use and allow the burden to slip along the length of the support pole, creating an unstable load which is difficult to carry on rough terrain.

Thus, there is a continuing need for a system for carrying a large game animal which can be conveniently carried in a disassembled state, assembled at a site of use, and which is configured to securely attach a load to be carried.

### SUMMARY OF THE INVENTION

An animal carrier system of the present invention provides for moving large animals. An inventive system can be disassembled into a manageable size, placed in a carry bag and easily transported and stored. Optionally padding is included where the device touches the shoulder of the persons carrying the animal making the device comfortable as it lays on the shoulder. Optionally, grips are included where the device is held during use in transporting an animal to male use of the system more comfortable for the user.

An attachment device is described according to the present invention which attaches the animal to the pole and secures the animal in place.

An animal carrier system of the present invention is lightweight, strong, economical in cost to produce and affordable to the consumer.

Advantageously, an animal carrier system of the present invention that can be easily used by two people to move large animals with little resistance from obstacles on the ground.

In particular embodiments of an animal carrier system of the present invention, a harness is provided including a cam lock, fasteners and straps which are connectable into one assembly to minimize the number of separate parts that needed to attach the animal to the support pole.

A curved portion on the support pole is optionally included to allow consistent placement of the pole on the shoulder of each person using an animal carrier system of the present invention, also keeping the people separated to a desired distance and also not allowing the pole to slide back and forth on the shoulder.

It is appreciated that an animal carrier system of the present invention allows a user to lift and move objects other than animals.

A portable carrier for an animal carcass is provided according to embodiments of the present invention which includes a support pole assembled from two component tubular member endpieces. The first and second tubular member endpieces each extend longitudinally between a first end and a second end and each endpiece has a bend configured to generally conform to a human shoulder proximate the first end. A third tubular member intermediate joining piece is reversibly attached to the second end of the first tubular endpiece member and to the second end of the second tubular endpiece member to form an assembled support pole. The endpiece members can be secured to the intermediate joining member, for instance, using reciprocally interlocking components disposed on the endpiece members and the intermediate joining member. Reciprocally interlocking components illustratively include, but are not limited to, spring buttons and corresponding holes, latch mechanisms, engaging bayonet connectors and cooperating screw threads. First and second attachment elements are disposed on the first and second tubular member endpieces, respectively, for reversibly attaching an animal carcass to the assembled support pole. Attachment elements can be in any form suitable for attachment of animal carcass securing devices, such as, but not limited to, rings fixedly attached to the endpieces for reversible attachment of straps.

First and second animal carcass securing harnesses are provided for attachment to the first and second attachment elements on the support pole. Each harness includes a strap assembly including a leg strap for encompassing a pair of legs of an animal carcass and a torso strap for encompassing the torso of an animal carcass. The leg strap is reversibly or fixedly connected to the torso strap and generally oriented to extend perpendicularly with respect to the torso strap. Straps included in animal carcass securing devices according to embodiments of the present invention, such as harnesses, can be any type of strap known in the art, exemplified by, but not limited to, synthetic material such as elastic, nylon, polypropylene, neoprene, or natural material such as natural fiber rope.

Each harness is adjustable to increase or decrease a distance between the assembled support pole and an attached animal carcass. For example, a harness includes one or more fasteners, such as friction buckles, cam lock buckles, rectangular loop or prong buckles, side release attachment devices, segments of hook-and-loop material, grommets, snaps or any known adjustable strap attachment device.

Also included in preferred embodiments is an animal carcass securing device including a strap for encompassing a portion an animal carcass head, configured for reversible attachment to the first or the second attachment element and adjustable to increase or decrease the distance between the assembled support pole and the animal carcass head.

In preferred embodiments, animal carcass securing devices are equipped with a fastener for engaging an attachment element and thereby attaching the animal carcass securing device to the support pole. Such fasteners illustratively include, but are not limited to, snaps for engaging a ring attachment element on the support pole such as, but not limited to, a bolt snap, a trigger snap, a spring snap, a breeching snap and a carabineer.

Optionally, padding encompassing the bend proximate the first end of each of the endpieces is included. In a further option, a hand grip element is disposed on each of the first and second tubular member endpieces between the bend and the first end of each of the first and second tubular member endpieces.

A portable animal carrier system is provided according to embodiments of the present invention which includes first, second and third tubular members assemblable to form a support pole, first and second animal carcass securing harnesses for securing an animal carcass to the support pole, an animal carcass securing device for supporting the head of the animal carcass and a container for carrying the first, second and third tubular members, the first and second animal carcass securing harnesses and the animal carcass securing device.

### BRIEF DESCRIPTION OF THE DRAWINGS

FIG. 1 is a plan drawing of an animal carcass carrier according to embodiments of the present invention in use;

FIG. 2 is an exploded view of components of an embodiment of a support pole and illustrates their assembly;

FIG. 3 is a sectional view of an endpiece and an intermediate joining piece of an embodiment of a support pole connected by the use of snap buttons in embodiments of the present invention;

FIG. 4 is sectional view showing internal and external components of a snap button used to connect endpieces and the intermediate joining piece together in embodiments of the present invention;

FIG. 5 is a perspective view of an embodiment of a leg strap portion of a harness including a cam-lock, snap hook, Velcro® strap and webbing;

FIG. 6 is a sectional view of a curved portion of an endpiece component of an embodiment of an assemblable support pole with an optional foam padding on the curved portion of the pole that allows for comfort of persons carrying the pole; and

FIG. 7 is a plan drawing of a user carrying a carrying device for use with a disassembled system of the present invention.

### DETAILED DESCRIPTION OF THE PREFERRED EMBODIMENTS

A system for carrying a large game animal is provided according to the present invention.

The system of present invention makes retrieving game animals such as deer or other animals of similar size much easier and comfortable than previous designs. The present invention is designed for two people to completely lift the animal off of the ground and embodiments are described which allow for consistent placement of an assembled support pole on the shoulder of each person carrying the pole each time it is used. This design helps avoid obstacles on the ground when retrieving the animal from the field and is also much easier and much more comfortable to use. The present invention is simple to assemble and when disassembled it can be placed in a small bag with a shoulder strap and easily transported to and from the field and can be easily stored.

A system for carrying a large game animal according to embodiments of the present invention includes an assemblable support pole and two assemblable harnesses for attachment of the large game animal to the support pole.

In particular embodiments, a support pole is assembled by attaching two generally longitudinally extending endpieces to an intermediate longitudinally extending joining piece. In preferred embodiments, each endpiece is configured to conform to a human shoulder allowing for consistent placement of an assembled support pole on the shoulder of each person carrying the assembled support pole each time it is used. Optionally, padding is removably or fixedly attached to the portion of the endpieces configured to conform to a human shoulder.

In preferred embodiments, each endpiece of the support pole has a fixed attachment member for attaching a harness to the support pole.

A harness is provided for attaching a load, particularly a large game animal to the assembled support pole. In a particular embodiment, the harness is assemblable, including a torso strap for encompassing the torso of a large game animal, and a leg strap for encompassing the leg of the animal. The leg strap is configured to reversibly attach the torso strap thereto. The leg strap also includes an attachment member for reversibly securing the torso strap to a fixed attachment member on the assembled support pole. Two harnesses are ordinarily used to attach an animal to the support pole, that is, one harness encompassing and supporting the front portion of the torso and front legs and a second harness encompassing and supporting the rear portion of the torso and back legs.

In a preferred option, a head strap is included in a system of the present invention for supporting the head of a large game animal. The head strap encompasses the head, neck or antlers of the animal and reversibly attaches to a fixed attachment apparatus of the assembled support pole.

In a further option, each endpiece includes a handgrip disposed at the endpiece terminus farthest from the intermediate longitudinally extending joining piece of the assembled support pole.

Referring now to the drawings, embodiments of the present invention include assemblable support pole components including two endpieces 1, an intermediate joining piece 10, torso straps 2, cam style locks 3, fasteners 4, rings 5, leg straps 8 and a head strap 12.

Optional padding 6 and grips 11 may be included for added comfort of users. The curved portions of the support pole present under padding or foam 6 allow for consistent placement of the invention on the shoulder of a person carrying the pole and inhibit horizontal sliding of the pole on the shoulder of a user. The optional padding 6 between the curved portion of pole 1 and the user's shoulder creates a separation between the pole 1 and the user's shoulder, creating, a more comfortable surface.

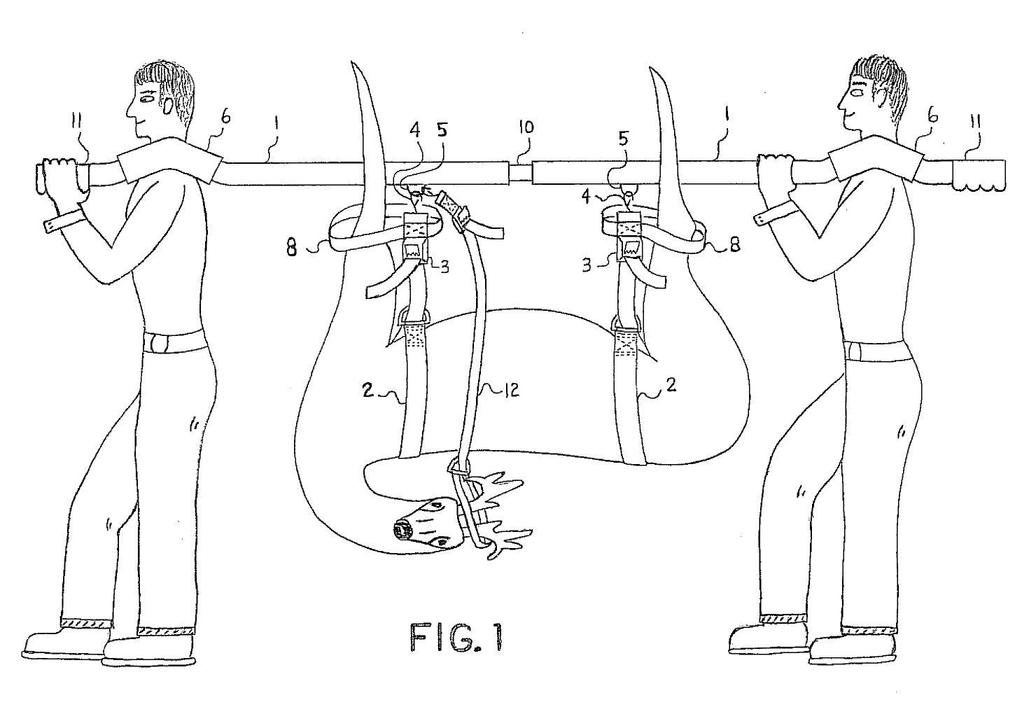

FIG. 1 illustrates an embodiment including torso straps 2, attached to cam style locks 3, fasteners 4 and rings 5 allowing an animal carcass to be connected to the assembled pole. FIG. 1 further illustrates an embodiment in which adjustable cam style locks 3 are included to allow the animal carcass to be positioned close to the assembled support pole or further away from the assembled support pole.

FIG. 1 shows torso straps 2 wrapped around the torso of the animal, supporting the animal in two locations, allowing the animal to be attached to the pole and lifted completely off of the ground. Also shown in FIG. 1 are leg straps 8 wrapped around the front legs and back legs of the animal securing the front legs and back legs of the animal to the assembled pole. Further included in embodiments of the present invention and illustrated in FIG. 1 is a head strap 12, used to support the head of the animal carcass off of the ground.

FIG. 1 shows one user's hands positioned on the assembled pole using a grip 11 for comfort and to stabilize the pole with the animal carcass attached.

FIG. 1 shows the way in which the animal is completely lifted off the ground by two people easily being transported to any location.

FIG. 1 shows the location of an intermediate joining piece 10 in the form of a smaller diameter pole that is inserted into each curved, larger diameter endpiece 1 to form an assembled support pole.

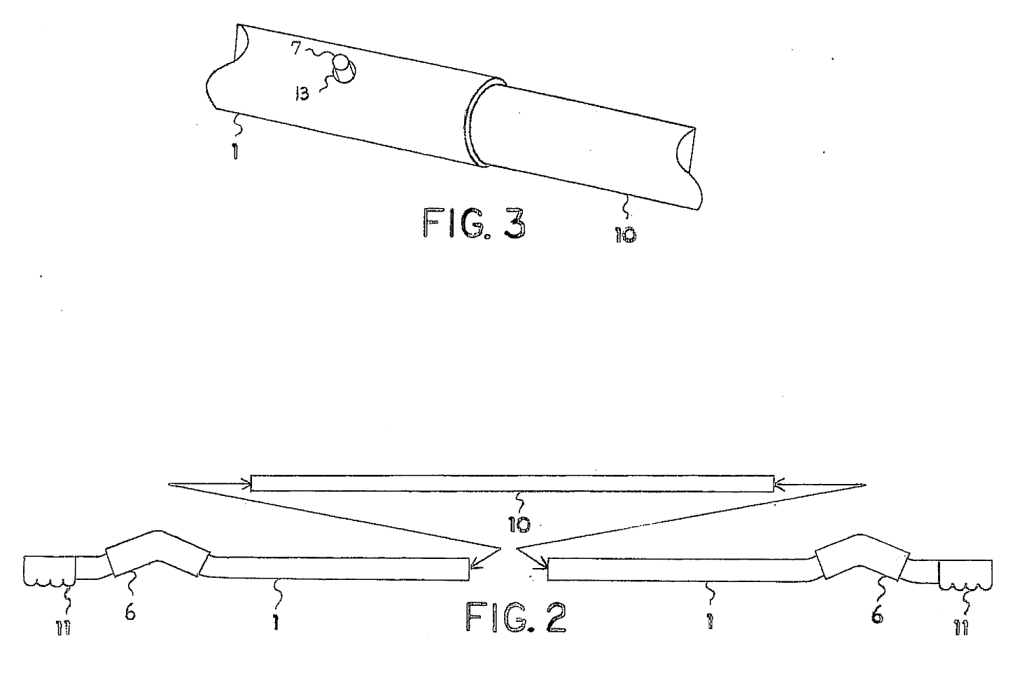

FIG. 2 illustrates assembly of two endpieces 1 and a joining piece 10 are assembled to form an assembled support pole. Optional padding 6 and grips 11 are also shown. All numerals correspond to those elements previously described.

FIG. 3 shows a sectional view of an embodiment of the present invention including a hole 13 in endpiece 1 which allows the raised portion of the spring button snap 7 to extend through endpiece 1 when intermediate joining piece 10 is inserted into endpiece 1 allowing a connection between endpiece 1 and intermediate joining piece 10, thereby creating a portion of an assembled support pole. All numerals correspond to those elements previously described.

FIG. 3 shows how the outside diameter of intermediate joining piece 10 is smaller than the inside diameter of endpiece 1 allowing intermediate joining piece 10 to be inserted into endpiece 1 without restriction or interference.

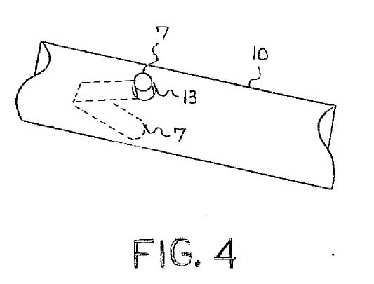

FIG. 4 shows a sectional view of a spring button snap 7 located on the inside diameter of intermediate joining piece 10 with the raised portion of the spring button snap extending beyond the outside diameter of intermediate joining piece 10. Spring button snaps 7 may be depressed making the spring button snap flush with the outside diameter of intermediate joining piece 10 enabling intermediate joining piece 10 to be inserted without restriction or interference into the larger diameter endpiece 1 which has a corresponding hole for mated reciprocal attachment. All numerals correspond to those elements previously described.

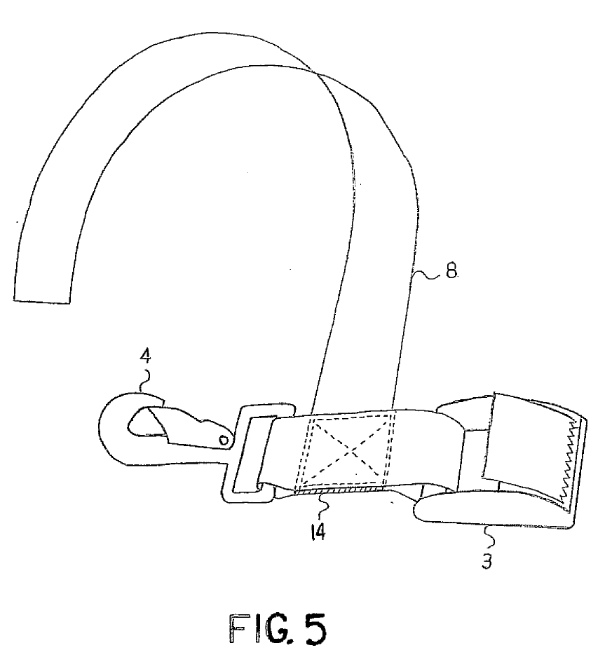

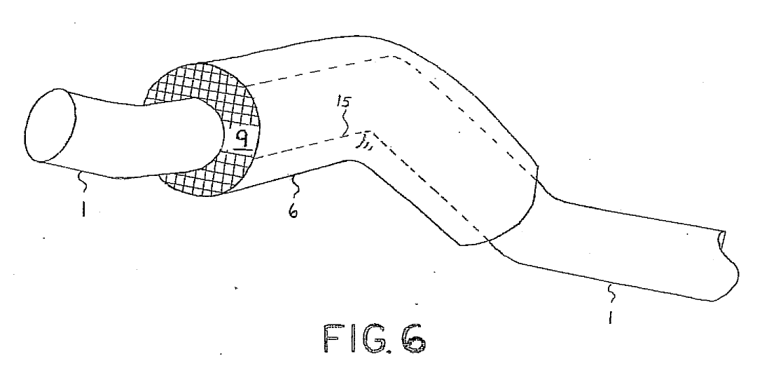

FIG. 5 shows a leg strap portion of a harness according to an embodiment of the present invention including a fastener 4, a cam style lock 3 and a leg strap 8 assembled to make harness 14, reducing the number of separate parts. All repeated numerals correspond to those elements previously described.

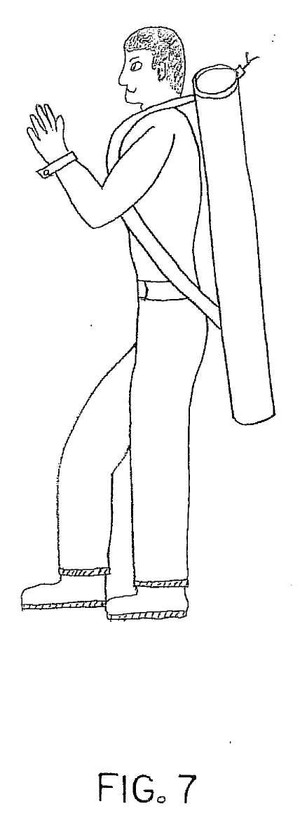

FIG. 6 illustrates a curved portion of an endpiece component of an embodiment of an assemblable support pole designed for consistent placement of the pole on the shoulder. This curved design does not allow the pole to slip back and forth horizontally on the shoulder for a more stable structure. Illustrated is an optional foam padding 6 on the curved portion of the pole that allows for comfort as the pole is lying on the shoulder of the person. FIG. 6 also shows the cross sectional view 9 of the padding 6 having a wall thickness to provide adequate separation between endpiece 1 and the shoulder of a person carrying the assembled pole, shown as the distance between the wall of the endpiece 15 and the padding 6. The padding 6 is illustrated as generally cylindrical in shape and encompassing the outside diameter of the curved portion of endpiece 1. All numerals in FIG. 6 correspond to those elements previously described.

The endpieces 1 and intermediate joining piece are generally constructed of tubular steel; however, composite materials or other materials of suitable strength and durability can also be used as will be recognized by one of skill in the art. For example, endpieces 1 and intermediate joining piece 10 can be manufactured of tubular material including, but not limited to, steel, aluminum, titanium and other materials such as composites, graphite, pultruded fiberglass and the like.

In a particular embodiment, an animal carcass carrier of the present invention includes steel fasteners 4, steel cam style locks 3, and fabric webbing strapping with at least one VELCRO fastener 8. However, other suitable materials can also be used for each of these components as will be recognized by one of skill in the art.

The primary holding mechanism 2 is recommended to be made of fabric webbing; however other materials can also be used as will be recognized by one of skill in the art.

The primary padding 6 is recommended to be constructed of foam material; however other materials, such as, but not limited to, rubber, can also be used as will be recognized by one of skill in the art.

Any patents or publications mentioned in this specification are incorporated herein by reference to the same extent as if each individual publication is specifically and individually indicated to be incorporated by reference.

The apparatus and methods described herein are presently representative of preferred embodiments, exemplary, and not intended as limitations on the scope of the invention. Changes therein and other uses will occur to those skilled in the art.

1. A portable carrier for an animal carcass, the animal carcass having a head, torso, a pair of front legs and a pair of back legs, comprising:
a first tubular endpiece member extending longitudinally between a first end and a second end, the first tubular endpiece member having a bend proximate the first end, the bend configured to generally conform to a human shoulder;
a second tubular endpiece member extending longitudinally between a first end and a second end, the second tubular endpiece member having a bend proximate the first end, the bend configured to generally conform to a human shoulder;
a third tubular member reversibly attached to the second end of the first tubular endpiece member and to the second end of the second tubular endpiece member to form an assembled support pole; and
a first attachment element disposed on the first tubular endpiece member for reversibly attaching an animal carcass to the assembled support pole;
a second attachment element disposed on the second tubular endpiece member for reversibly attaching an animal carcass to the assembled support pole;
a first and a second animal carcass securing harness, each harness comprising a leg strap for encompassing a pair of legs of an animal carcass and a torso strap for encompassing the torso of an animal carcass, the leg strap connected to the torso strap and generally oriented to extend perpendicularly with respect to the torso strap, each harness further configured for reversible attachment of the harness to the first attachment element or the second attachment element and each harness adjustable to increase or decrease a distance between the assembled support pole and an attached animal carcass; and
an animal carcass securing device comprising a strap for encompassing a portion an animal carcass head, the animal carcass securing device further configured for reversible attachment to the first attachment element or the second attachment element and the device adjustable to increase or decrease a distance between the assembled support pole and the animal carcass head.

2. The portable carrier of claim 1, further comprising padding encompassing the bend proximate the first end of the first tubular endpiece member and the bend proximate the first end of the second tubular endpiece member.

3. A portable carrier for an animal carcass, the animal carcass having a head, torso, a pair of front legs and a pair of back legs, comprising:
a first tubular endpiece member extending longitudinally between a first end and a second end, the first tubular endpiece member having a bend proximate the first end;
a second tubular endpiece member extending longitudinally between a first end and a second end, the second tubular endpiece member having a bend proximate the first end;
a joining piece reversibly attached to the second end of the first tubular endpiece member and to the second end of the second tubular endpiece member to form an assembled support pole; and
a first attachment element disposed on the assembled support pole for reversibly attaching an animal carcass to the assembled support pole.

4. The portable carrier of claim 3, wherein the joining piece comprises a third tubular member extending longitudinally between a first end and a second end, and wherein the first end of the third tubular member inserts into the second end of the first tubular endpiece member and the second end of the third tubular member inserts into the second end of the second tubular endpiece member, thereby connecting the first and second tubular endpiece members to form an assembled support pole.

5. The portable carrier of claim 4, wherein the first end and the second end of the third tubular member are each adapted to reciprocally engage an interlocking mechanism on the second end of the first tubular endpiece member and on the second end of the second tubular endpiece member.

6. The portable carrier of claim 3, further comprising a second attachment element disposed on the support pole for reversibly attaching an animal carcass to the assembled support pole.

7. The portable carrier of claim 6, wherein the first attachment element disposed on the assembled support pole is disposed on the first tubular endpiece member and the second attachment element disposed on the assembled support pole is disposed on the second tubular endpiece member.

8. The portable carrier of claim 3, further comprising a first animal carcass securing device for reversibly securing an animal carcass to the first attachment element.

9. The portable carrier of claim 8, further comprising a second animal carcass securing device for reversibly securing an animal carcass to the second attachment element.

10. The portable carrier of claim 9, wherein the first animal carcass securing device is reversibly secured to the pair of front legs of the animal carcass, to the torso of the animal carcass and to the first attachment element of the assembled support pole and wherein the second animal carcass securing device is reversibly secured to the pair of back legs of the animal carcass, the torso of the animal carcass and to the second attachment element of the assembled support pole.

11. The portable carrier of claim 10, wherein the first and second animal carcass securing devices each comprise a harness, each harness comprising a leg strap for encompassing a pair of legs of an animal carcass and a torso strap for encompassing the torso of an animal carcass, the leg strap connected to the torso strap and generally oriented to extend perpendicularly with respect to the torso strap.

12. The portable carrier of claim 9, further comprising a third animal carcass securing device for reversibly attaching the head of an animal carcass to the assembled support pole.

13. The portable carrier of claim 12, wherein the third animal carcass securing device reversibly attaches to the first attachment element.

14. The portable carrier of claim 8, wherein the first animal carcass securing device is adjustable to increase or decrease a distance between an attached animal carcass and the assembled support pole.

15. The portable carrier of claim 9, wherein the first and second animal carcass securing devices are each adjustable to increase or decrease a distance between an attached animal carcass and the assembled support pole.

16. The portable carrier of claim 12, wherein the first, second and third animal carcass securing devices are each adjustable to increase or decrease a distance between an attached animal carcass and the assembled support pole.

17. The portable carrier of claim 3, wherein the bend proximate the first end of the first tubular endpiece member and the bend proximate the first end of the second tubular endpiece member are configured to accommodate a human shoulder.

18. The portable carrier of claim 3, further comprising a hand grip element disposed on each of the first and second tubular member endpieces between the bend and the first end of each of the first and second tubular member endpieces.

19. A system for carrying an animal carcass, comprising:
a first tubular endpiece member extending longitudinally between a first end and a second end, the first tubular endpiece member having a bend proximate the first end, the bend configured to generally conform to a human shoulder;
a second tubular endpiece member extending longitudinally between a first end and a second end, the second tubular endpiece member having a bend proximate the first end, the bend configured to generally conform to a human shoulder;
a third tubular member reversibly attached to the second end of the first tubular endpiece member and to the second end of the second tubular endpiece member to form an assembled support pole; and
a first attachment element disposed on the first tubular endpiece member for reversibly attaching an animal carcass to the assembled support pole;
a second attachment element disposed on the second tubular endpiece member for reversibly attaching an animal carcass to the assembled support pole;
a first and a second animal carcass securing harness, each harness comprising a leg strap for encompassing a pair of legs of an animal carcass and a torso strap for encompassing the torso of an animal carcass, the leg strap connected to the torso strap and generally oriented to extend perpendicularly with respect to the torso strap, each harness further configured for reversible attachment of the harness to the first attachment element or the second attachment element and each harness adjustable to increase or decrease a distance between the assembled support pole and an attached animal carcass;
an animal carcass securing device comprising a strap for encompassing a portion an animal carcass head, the animal carcass securing device further configured for reversible attachment to the first attachment element or the second attachment element and the device adjustable to increase or decrease a distance between the assembled support pole and the animal carcass head; and
a container for carrying the first, second and third tubular members, the first and second animal carcass securing harnesses and the animal carcass securing device.
